(19) United States
(12) Patent Application Publication
(10) Pub. No.: US 2023/0419697 A1
(43) Pub. Date: Dec. 28, 2023

(54) IMAGE TAGGING ENGINE SYSTEMS AND METHODS FOR PROGRAMMABLE LOGIC DEVICES

(71) Applicant: Lattice Semiconductor Corporation, Hillsboro, OR (US)

(72) Inventors: Hoon Choi, Mountain View, CA (US); Ju Hwan Yi, Sunnyvale, CA (US)

(21) Appl. No.: 18/464,175

(22) Filed: Sep. 8, 2023

Related U.S. Application Data
(63) Continuation of application No. PCT/US2022/019837, filed on Mar. 10, 2022.
(60) Provisional application No. 63/159,394, filed on Mar. 10, 2021.

(51) Int. Cl. G06V 20/70; G06F 15/78; G06T 5/40; G06T 5/00; G06F 1/3206

(52) U.S. Cl. CPC G06V 20/70; G06F 15/7867; G06T 5/40; G06T 5/007; G06F 1/3206

(57) ABSTRACT

Systems and methods for controlling the operation of an electronic system are disclosed. An example electronic system includes an edge PLD including programmable logic blocks (PLBs) configured to implement an image engine preprocessor and an image engine. The edge PLD is configured to receive raw imagery provided by an imaging module of the electronic system via a raw image pathway of the electronic system; to generate, via the image engine preprocessor, engine-quality imagery corresponding to the received raw imagery; and to generate, via the image engine of the edge PLD, one or more image tags associated with the generated engine-quality imagery. The one or more image tags and/or the associated engine-quality imagery is used to control operation of the electronic system.

### CROSS-REFERENCE TO RELATED APPLICATION

This patent application is a continuation of International Application No. PCT/US2022/019837, filed Mar. 10, 2022 and entitled “IMAGE TAGGING ENGINE SYSTEMS AND METHODS FOR PROGRAMMABLE LOGIC DEVICES”, which is claimed for the benefit of and incorporated herein by reference in its entirety.

International Application No. PCT/US2022/019837 claims the benefit of and priority to U.S. Provisional Patent Application No. 63/159,394 filed Mar. 10, 2021 and entitled “IMAGE TAGGING ENGINE SYSTEMS AND METHODS FOR PROGRAMMABLE LOGIC DEVICES,” which is incorporated herein by reference in its entirety.

### TECHNICAL FIELD

The present invention relates generally to programmable logic devices and, more particularly, to relatively low power image processing engines implemented by such devices.

### BACKGROUND

Programmable logic devices (PLDs) (e.g., field programmable gate arrays (FPGAs), complex programmable logic devices (CPLDs), field programmable systems on a chip (FPSCs), or other types of programmable devices) may be configured with various user designs to implement desired functionality. Typically, user designs are synthesized and mapped into configurable resources (e.g., programmable logic gates, look-up tables (LUTs), embedded hardware, or other types of resources) and interconnections available in particular PLDs. Physical placement and routing for the synthesized and mapped user designs may then be determined to generate configuration data for the particular PLDs.

Electronic systems, such as personal computers, servers, laptops, smart phones, and/or other personal and/or portable electronic devices, increasingly include imaging devices and applications to provide video communications and/or other relatively sophisticated imagery-based features for their users. However, many such applications are relatively compute intensive and can present a significant power draw, which can in turn significantly limit the operational flexibility of such systems, and particularly portable electronic devices. Thus, there is a need in the art for systems and methods to provide relatively low power image processing configured to facilitate sophisticated imagery-based features and applications.

### BRIEF DESCRIPTION OF THE FIGURES

FIG. 1 illustrates a block diagram of a programmable logic device (PLD) in accordance with an embodiment of the disclosure.

FIG. 2 illustrates a block diagram of a logic block for a PLD in accordance with an embodiment of the disclosure.

FIG. 3 illustrates a design process for a PLD in accordance with an embodiment of the disclosure.

FIG. 4 illustrates a block diagram of an electronic system including an edge PLD in accordance with an embodiment of the disclosure.

FIG. 5 illustrates a data flow diagram of an electronic system including an edge PLD in accordance with an embodiment of the disclosure.

FIG. 6A illustrates a block diagram of a training system for an edge PLD in accordance with an embodiment of the disclosure.

FIG. 6B illustrates imagery processed by an edge PLD in accordance with an embodiment of the disclosure.

FIG. 7 illustrates a process for operating an electronic system including an edge PLD in accordance with an embodiment of the disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for implementing relatively low power image processing within of a programmable logic device (PLD) for use in relatively sophisticated imaging-based applications and architectures, as described herein. For example, embodiments provide systems and methods for implementing imagery-based neural network, machine learning, artificial intelligence, and/or other relatively sophisticated processing within a relatively low power PLD, which may be used to control operation of an electronic system incorporating the PLD.

In particular, raw imagery captured by a camera or other imaging module integrated with a contemporary electronic system can often be unsuitable for image tagging (e.g., feature extraction, segmentation, object recognition, classification, and/or other neural network, machine learning, and/or artificial intelligence-based image tagging) due to low light, over saturation, and/or other common unfavorable image capture circumstances and/or characteristics. An electronic system may use a primary controller (e.g., a CPU and/or GPU) to process such unsuitable raw imagery into a form suitable for image tagging, but powering such main controller to do so can use significant power reserves, and such processing is often performed at human-quality levels suitable for human viewing, which can use more than a desirable portion of the available compute resources of the primary controller(s).

Embodiments reduce or eliminate the need to power or employ such primary controllers to perform such processing by implementing the processing within a relatively low power edge PLD configured to preprocess the raw imagery at an image processing engine-quality level suitable for reliable image tagging but below the quality level typically suitable for human viewing. Such image tagging may then be used to control operation of the electronic system, regardless of the power and/or sleep state of the electronic system, for example, and may be linked with human-quality processed versions of the raw imagery to produce tagged imagery suitable for human viewing and/or other applications, as described herein. Embodiments may be trained to perform reliable image tagging using human-quality training sets of training images and associated image tagging that are first de-optimized to mimic common unfavorable image capture circumstances and/or characteristics, as described herein. The resulting trained image engines may be used for image tagging for use in a variety of applications, including user presence-based power on, power off, waking, sleeping, authentication, deauthentication, shoulder-surfing detection, and/or other operational control of electronic systems and/or applications executed by such electronic systems.

In accordance with embodiments set forth herein, techniques are provided to implement user designs in programmable logic devices (PLDs). In various embodiments, a user design may be converted into and/or represented by a set of PLD components (e.g., configured for logic, arithmetic, or other hardware functions) and their associated interconnections available in a PLD. For example, a PLD may include a number of programmable logic blocks (PLBs), each PLB including a number of logic cells, and configurable routing resources that may be used to interconnect the PLBs and/or logic cells. In some embodiments, each PLB may be implemented with between 2 and 16 or between 2 and 32 logic cells.

In general, a PLD (e.g., an FPGA) fabric includes one or more routing structures and an array of similarly arranged logic cells arranged within programmable function blocks (e.g., PFBs and/or PLBs). The purpose of the routing structures is to programmably connect the ports of the logic cells/PLBs to one another in such combinations as necessary to achieve an intended functionality. An edge PLD (e.g., a PLD configured for relatively low power operation substantially independent from an electronic system incorporating the edge PLD) may include various additional “hard” or “soft” engines or modules configured to provide a range of image processing functionality that may be linked to operation of the PLD fabric to provide configurable image processing functionality and/or architectures, as described herein. For example, an edge PLD may be a PLD integrated with an imaging module and/or otherwise located at a point of image capture, for example, or used where always-on power concerns are paramount for general operation of an electronic system incorporating the edge PLD (e.g., a battery powered and/or portable electronic system, as described herein). Routing flexibility and configurable function embedding may be used when synthesizing, mapping, placing, and/or routing a user design into a number of PLD components. As a result of various user design optimization processes, which can incur significant design time and cost, a user design can be implemented relatively efficiently, thereby freeing up configurable PLD components that would otherwise be occupied by additional operations and routing resources. In some embodiments, an optimized user design may be represented by a netlist that identifies various types of components provided by the PLD and their associated signals. In embodiments that produce a netlist of the converted user design, the optimization process may be performed on such a netlist. Once optimized, such configuration may be encrypted and signed and/or otherwise secured for distribution to an edge PLD, as described herein.

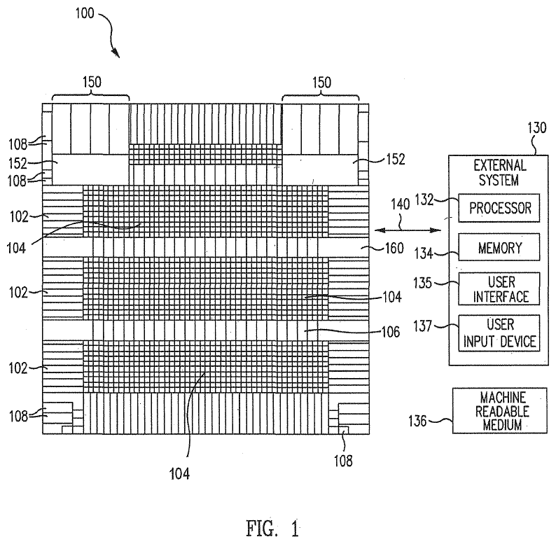

Referring now to the drawings, FIG. 1 illustrates a block diagram of a PLD 100 in accordance with an embodiment of the disclosure. PLD 100 (e.g., a field programmable gate array (FPGA)), a complex programmable logic device (CPLD), a field programmable system on a chip (FPSC), or other type of programmable device) generally includes input/output (I/O) blocks 102 and logic blocks 104 (e.g., also referred to as programmable logic blocks (PLBs), programmable functional units (PFUs), or programmable logic cells (PLCs)). More generally, the individual configurable elements of PLD 100 may be referred to as a PLD fabric.

I/O blocks 102 provide I/O functionality (e.g., to support one or more I/O and/or memory interface standards) for PLD 100, while programmable logic blocks 104 provide logic functionality (e.g., LUT-based logic or logic gate array-based logic) for PLD 100. Additional I/O functionality may be provided by serializer/deserializer (SERDES) blocks 150 and physical coding sublayer (PCS) blocks 152. PLD 100 may also include hard intellectual property core (IP) blocks 160 to provide additional functionality (e.g., substantially predetermined functionality provided in hardware which may be configured with less programming than logic blocks 104).

PLD 100 may also include blocks of memory 106 (e.g., blocks of EEPROM, block SRAM, and/or flash memory), clock-related circuitry 108 (e.g., clock sources, PLL circuits, and/or DLL circuits), and/or various routing resources 180 (e.g., interconnect and appropriate switching logic to provide paths for routing signals throughout PLD 100, such as for clock signals, data signals, or others) as appropriate. In general, the various elements of PLD 100 may be used to perform their intended functions for desired applications, as would be understood by one skilled in the art.

For example, certain I/O blocks 102 may be used for programming memory 106 or transferring information (e.g., various types of user data and/or control signals) to/from PLD 100. Other I/O blocks 102 include a first programming port (which may represent a central processing unit (CPU) port, a peripheral data port, an SPI interface, and/or a sysCONFIG programming port) and/or a second programming port such as a joint test action group (JTAG) port (e.g., by employing standards such as Institute of Electrical and Electronics Engineers (IEEE) 1149.1 or 1532 standards). In various embodiments, I/O blocks 102 may be included to receive configuration data and commands (e.g., over one or more connections 140) to configure PLD 100 for its intended use and to support serial or parallel device configuration and information transfer with SERDES blocks 150, PCS blocks 152, hard IP blocks 160, and/or logic blocks 104 as appropriate.

It should be understood that the number and placement of the various elements are not limiting and may depend upon the desired application. For example, various elements may not be required for a desired application or design specification (e.g., for the type of programmable device selected).

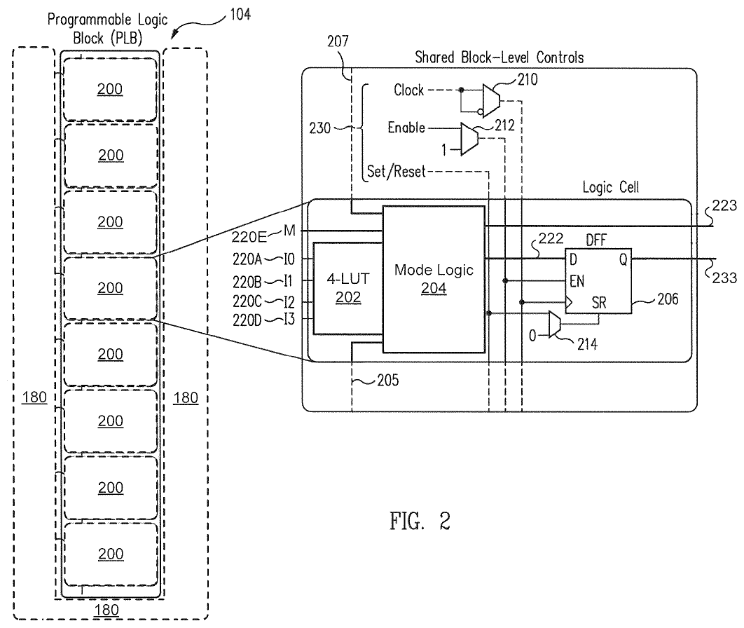

Furthermore, it should be understood that the elements are illustrated in block form for clarity and that various elements would typically be distributed throughout PLD 100, such as in and between logic blocks 104, hard IP blocks 160, and routing resources (e.g., routing resources 180 of FIG. 2) to perform their conventional functions (e.g., storing configuration data that configures PLD 100 or providing interconnect structure within PLD 100). It should also be understood that the various embodiments disclosed herein are not limited to programmable logic devices, such as PLD 100, and may be applied to various other types of programmable devices, as would be understood by one skilled in the art.

An external system 130 may be used to create a desired user configuration or design of PLD 100 and generate corresponding configuration data to program (e.g., configure) PLD 100. For example, system 130 may provide such configuration data to one or more I/O blocks 102, SERDES blocks 150, and/or other portions of PLD 100. As a result, programmable logic blocks 104, various routing resources, and any other appropriate components of PLD 100 may be configured to operate in accordance with user-specified applications.

In the illustrated embodiment, system 130 is implemented as a computer system. In this regard, system 130 includes, for example, one or more processors 132 which may be configured to execute instructions, such as software instructions, provided in one or more memories 134 and/or stored in non-transitory form in one or more non-transitory machine-readable mediums 136 (e.g., which may be internal or external to system 130). For example, in some embodiments, system 130 may run PLD configuration software, such as Lattice Diamond System Planner software available from Lattice Semiconductor Corporation to permit a user to create a desired configuration and generate corresponding configuration data to program PLD 100.

System 130 also includes, for example, a user interface 135 (e.g., a screen or display) to display information to a user, and one or more user input devices 137 (e.g., a keyboard, mouse, trackball, touchscreen, and/or other device) to receive user commands or design entry to prepare a desired configuration of PLD 100.

FIG. 2 illustrates a block diagram of a logic block 104 of PLD 100 in accordance with an embodiment of the disclosure. As discussed, PLD 100 includes a plurality of logic blocks 104 including various components to provide logic and arithmetic functionality. In the example embodiment shown in FIG. 2, logic block 104 includes a plurality of logic cells 200, which may be interconnected internally within logic block 104 and/or externally using routing resources 180. For example, each logic cell 200 may include various components such as: a lookup table (LUT) 202, a mode logic circuit 204, a register 206 (e.g., a flip-flop or latch), and various programmable multiplexers (e.g., programmable multiplexers 212 and 214) for selecting desired signal paths for logic cell 200 and/or between logic cells 200. In this example, LUT 202 accepts four inputs 220A-220D, which makes it a four-input LUT (which may be abbreviated as “4-LUT” or “LUT4”) that can be programmed by configuration data for PLD 100 to implement any appropriate logic operation having four inputs or less. Mode Logic 204 may include various logic elements and/or additional inputs, such as input 220E, to support the functionality of various modes, as described herein. LUT 202 in other examples may be of any other suitable size having any other suitable number of inputs for a particular implementation of a PLD. In some embodiments, different size LUTs may be provided for different logic blocks 104 and/or different logic cells 200.

An output signal 222 from LUT 202 and/or mode logic 204 may in some embodiments be passed through register 206 to provide an output signal 233 of logic cell 200. In various embodiments, an output signal 223 from LUT 202 and/or mode logic 204 may be passed to output 223 directly, as shown. Depending on the configuration of multiplexers 210-214 and/or mode logic 204, output signal 222 may be temporarily stored (e.g., latched) in latch 206 according to control signals 230. In some embodiments, configuration data for PLD 100 may configure output 223 and/or 233 of logic cell 200 to be provided as one or more inputs of another logic cell 200 (e.g., in another logic block or the same logic block) in a staged or cascaded arrangement (e.g., comprising multiple levels) to configure logic operations that cannot be implemented in a single logic cell 200 (e.g., logic operations that have too many inputs to be implemented by a single LUT 202). Moreover, logic cells 200 may be implemented with multiple outputs and/or interconnections to facilitate selectable modes of operation, as described herein.

Mode logic circuit 204 may be utilized for some configurations of PLD 100 to efficiently implement arithmetic operations such as adders, subtractors, comparators, counters, or other operations, to efficiently form some extended logic operations (e.g., higher order LUTs, working on multiple bit data), to efficiently implement a relatively small RAM, and/or to allow for selection between logic, arithmetic, extended logic, and/or other selectable modes of operation. In this regard, mode logic circuits 204, across multiple logic cells 202, may be chained together to pass carry-in signals 205 and carry-out signals 207, and/or other signals (e.g., output signals 222) between adjacent logic cells 202, as described herein. In the example of FIG. 2, carry-in signal 205 may be passed directly to mode logic circuit 204, for example, or may be passed to mode logic circuit 204 by configuring one or more programmable multiplexers, as described herein. In some embodiments, mode logic circuits 204 may be chained across multiple logic blocks 104.

Logic cell 200 illustrated in FIG. 2 is merely an example, and logic cells 200 according to different embodiments may include different combinations and arrangements of PLD components. Also, although FIG. 2 illustrates logic block 104 having eight logic cells 200, logic block 104 according to other embodiments may include fewer logic cells 200 or more logic cells 200. Each of the logic cells 200 of logic block 104 may be used to implement a portion of a user design implemented by PLD 100. In this regard, PLD 100 may include many logic blocks 104, each of which may include logic cells 200 and/or other components which are used to collectively implement the user design. As further described herein, portions of a user design may be adjusted to occupy fewer logic cells 200, fewer logic blocks 104, and/or with less burden on routing resources 180 when PLD 100 is configured to implement the user design. Such adjustments according to various embodiments may identify certain logic, arithmetic, and/or extended logic operations, to be implemented in an arrangement occupying multiple embodiments of logic cells 200 and/or logic blocks 104. As further described herein, an optimization process may route various signal connections associated with the arithmetic/logic operations described herein, such that a logic, ripple arithmetic, or extended logic operation may be implemented into one or more logic cells 200 and/or logic blocks 104 to be associated with the preceding arithmetic/logic operations.

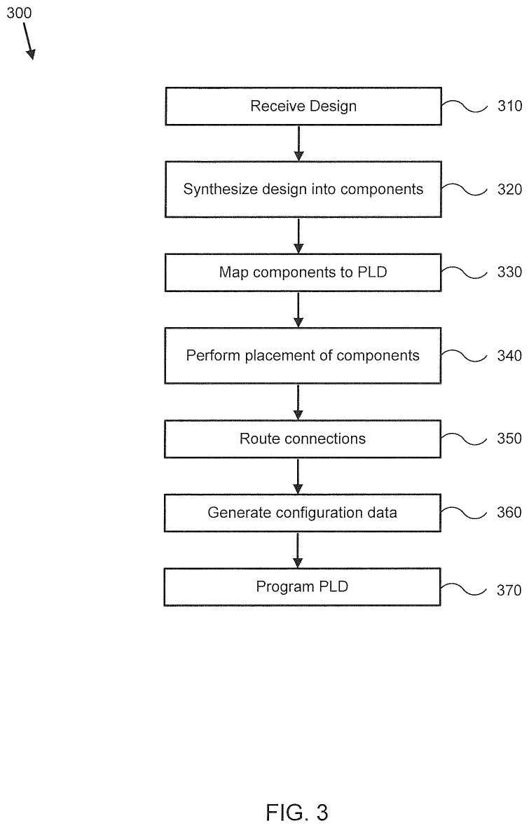

FIG. 3 illustrates a design process 300 for a PLD in accordance with an embodiment of the disclosure. For example, the process of FIG. 3 may be performed by system 130 running Lattice Diamond software to configure PLD 100. In some embodiments, the various files and information referenced in FIG. 3 may be stored, for example, in one or more databases and/or other data structures in memory 134, machine readable medium 136, and/or otherwise. In various embodiments, such files and/or information may be encrypted or otherwise secured when stored and/or conveyed to PLD 100 and/or other devices or systems.

In operation 310, system 130 receives a user design that specifies the desired functionality of PLD 100. For example, the user may interact with system 130 (e.g., through user input device 137 and hardware description language (HDL) code representing the design) to identify various features of the user design (e.g., high level logic operations, hardware configurations, and/or other features). In some embodiments, the user design may be provided in a register transfer level (RTL) description (e.g., a gate level description). System 130 may perform one or more rule checks to confirm that the user design describes a valid configuration of PLD 100. For example, system 130 may reject invalid configurations and/or request the user to provide new design information as appropriate.

In operation 320, system 130 synthesizes the design to create a netlist (e.g., a synthesized RTL description) identifying an abstract logic implementation of the user design as a plurality of logic components (e.g., also referred to as netlist components), which may include both programmable components and hard IP components of PLD 100. In some embodiments, the netlist may be stored in Electronic Design Interchange Format (EDIF) in a Native Generic Database (NGD) file.

In some embodiments, synthesizing the design into a netlist in operation 320 may involve converting (e.g., translating) the high-level description of logic operations, hardware configurations, and/or other features in the user design into a set of PLD components (e.g., logic blocks 104, logic cells 200, and other components of PLD 100 configured for logic, arithmetic, or other hardware functions to implement the user design) and their associated interconnections or signals. Depending on embodiments, the converted user design may be represented as a netlist.

In some embodiments, synthesizing the design into a netlist in operation 320 may further involve performing an optimization process on the user design (e.g., the user design converted/translated into a set of PLD components and their associated interconnections or signals) to reduce propagation delays, consumption of PLD resources and routing resources, and/or otherwise optimize the performance of the PLD when configured to implement the user design. Depending on embodiments, the optimization process may be performed on a netlist representing the converted/translated user design. Depending on embodiments, the optimization process may represent the optimized user design in a netlist (e.g., to produce an optimized netlist).

In some embodiments, the optimization process may include optimizing certain instances of a logic function operation, a ripple arithmetic operation, and/or an extended logic function operation which, when a PLD is configured to implement the user design, would occupy a plurality of configurable PLD components (e.g., logic cells 200, logic blocks 104, and/or routing resources 180). For example, the optimization process may include detecting multiple mode or configurable logic cells implementing logic function operations, ripple arithmetic operations, extended logic function operations, and/or corresponding routing resources in the user design, interchanging operational modes of logic cells implementing the various operations to reduce the number of PLD components and/or routing resources used to implement the operations and/or to reduce the propagation delay associated with the operations, and/or reprogramming corresponding LUTs and/or mode logic to account for the interchanged operational modes.

In another example, the optimization process may include detecting extended logic function operations and/or corresponding routing resources in the user design, implementing the extended logic operations into multiple mode or convertible logic cells with single physical logic cell outputs, routing or coupling the logic cell outputs of a first set of logic cells to the inputs of a second set of logic cells to reduce the number of PLD components used to implement the extended logic operations and/or routing resources and/or to reduce the propagation delay associated with the extended logic operations, and/or programming corresponding LUTs and/or mode logic to implement the extended logic function operations with at least the first and second sets of logic cells.

In another example, the optimization process may include detecting multiple mode or configurable logic cells implementing logic function operations, ripple arithmetic operations, extended logic function operations, and/or corresponding routing resources in the user design, interchanging operational modes of logic cells implementing the various operations to provide a programmable register along a signal path within the PLD to reduce propagation delay associated with the signal path, and reprogramming corresponding LUTs, mode logic, and/or other logic cell control bits/registers to account for the interchanged operational modes and/or to program the programmable register to store or latch a signal on the signal path.

In operation 330, system 130 performs a mapping process that identifies components of PLD 100 that may be used to implement the user design. In this regard, system 130 may map the optimized netlist (e.g., stored in operation 320 as a result of the optimization process) to various types of components provided by PLD 100 (e.g., logic blocks 104, logic cells 200, embedded hardware, and/or other portions of PLD 100) and their associated signals (e.g., in a logical fashion, but without yet specifying placement or routing). In some embodiments, the mapping may be performed on one or more previously-stored NGD files, with the mapping results stored as a physical design file (e.g., also referred to as an NCD file). In some embodiments, the mapping process may be performed as part of the synthesis process in operation 320 to produce a netlist that is mapped to PLD components.

In operation 340, system 130 performs a placement process to assign the mapped netlist components to particular physical components residing at specific physical locations of the PLD 100 (e.g., assigned to particular logic cells 200, logic blocks 104, routing resources 180, and/or other physical components of PLD 100), and thus determine a layout for the PLD 100. In some embodiments, the placement may be performed on one or more previously-stored NCD files, with the placement results stored as another physical design file.

In operation 350, system 130 performs a routing process to route connections (e.g., using routing resources 180) among the components of PLD 100 based on the placement layout determined in operation 340 to realize the physical interconnections among the placed components. In some embodiments, the routing may be performed on one or more previously-stored NCD files, with the routing results stored as another physical design file.

In various embodiments, routing the connections in operation 350 may further involve performing an optimization process on the user design to reduce propagation delays, consumption of PLD resources and/or routing resources, and/or otherwise optimize the performance of the PLD when configured to implement the user design. The optimization process may in some embodiments be performed on a physical design file representing the converted/translated user design, and the optimization process may represent the optimized user design in the physical design file (e.g., to produce an optimized physical design file).

In some embodiments, the optimization process may include optimizing certain instances of a logic function operation, a ripple arithmetic operation, and/or an extended logic function operation which, when a PLD is configured to implement the user design, would occupy a plurality of configurable PLD components (e.g., logic cells 200, logic blocks 104, and/or routing resources 180). For example, the optimization process may include detecting multiple mode or configurable logic cells implementing logic function operations, ripple arithmetic operations, extended logic function operations, and/or corresponding routing resources in the user design, interchanging operational modes of logic cells implementing the various operations to reduce the number of PLD components and/or routing resources used to implement the operations and/or to reduce the propagation delay associated with the operations, and/or reprogramming corresponding LUTs and/or mode logic to account for the interchanged operational modes.

In another example, the optimization process may include detecting extended logic function operations and/or corresponding routing resources in the user design, implementing the extended logic operations into multiple mode or convertible logic cells with single physical logic cell outputs, routing or coupling the logic cell outputs of a first set of logic cells to the inputs of a second set of logic cells to reduce the number of PLD components used to implement the extended logic operations and/or routing resources and/or to reduce the propagation delay associated with the extended logic operations, and/or programming corresponding LUTs and/or mode logic to implement the extended logic function operations with at least the first and second sets of logic cells.

In another example, the optimization process may include detecting multiple mode or configurable logic cells implementing logic function operations, ripple arithmetic operations, extended logic function operations, and/or corresponding routing resources in the user design, interchanging operational modes of logic cells implementing the various operations to provide a programmable register along a signal path within the PLD to reduce propagation delay associated with the signal path, and reprogramming corresponding LUTs, mode logic, and/or other logic cell control bits/registers to account for the interchanged operational modes and/or to program the programmable register to store or latch a signal on the signal path.

Changes in the routing may be propagated back to prior operations, such as synthesis, mapping, and/or placement, to further optimize various aspects of the user design.

Thus, following operation 350, one or more physical design files may be provided which specify the user design after it has been synthesized (e.g., converted and optimized), mapped, placed, and routed (e.g., further optimized) for PLD 100 (e.g., by combining the results of the corresponding previous operations). In operation 360, system 130 generates configuration data for the synthesized, mapped, placed, and routed user design. In various embodiments, such configuration data may be encrypted and/or otherwise secured as part of such generation process, as described more fully herein. In operation 370, system 130 configures PLD 100 with the configuration data by, for example, loading a configuration data bitstream (e.g., a “configuration”) into PLD 100 over connection 140. Such configuration may be provided in an encrypted, signed, or unsecured/unauthenticated form, for example, and PLD 100 may be configured to treat secured and unsecured configurations differently, as described herein.

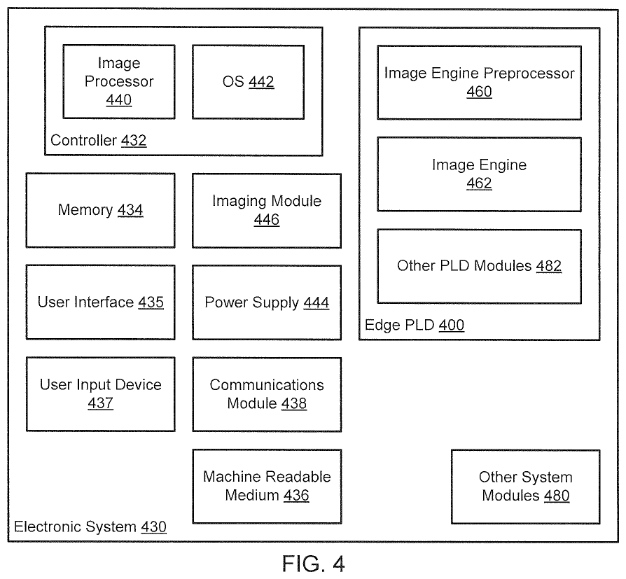

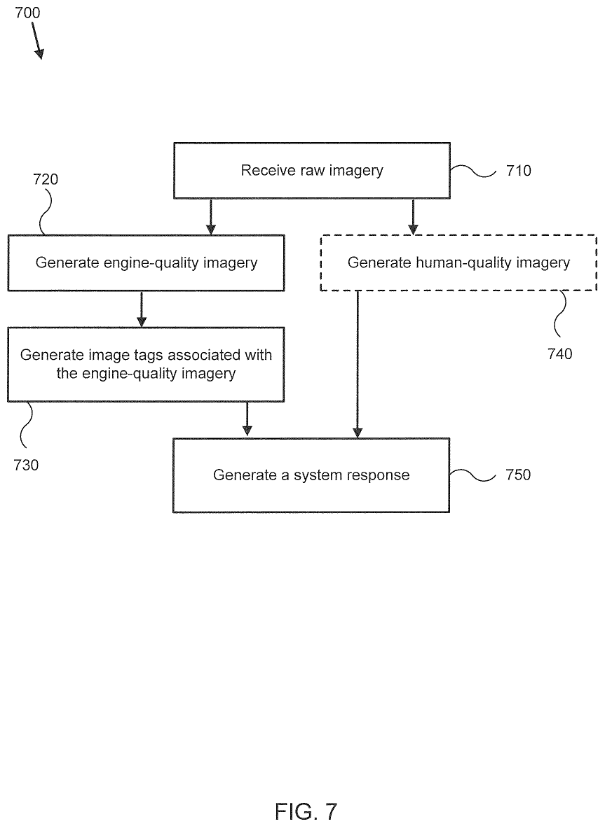

FIG. 4 illustrates a block diagram of an electronic system 430 including an edge PLD 400 in accordance with an embodiment of the disclosure. For example, one or more elements of electronic system 430 and/or edge PLD 400 may be configured to perform at least portions of the process described in relation to FIG. 7. In particular, electronic system 430 may be configured to use edge PLD 400 to perform low power, always-on, but relatively sophisticated image processing of raw imagery provided by imaging module 446 substantially independently of the rest of electronic system 430, for example, and/or synchronously with controller 432, so as to facilitate operation of electronic system 430, as described herein. In various embodiments, edge PLD 400 may be configured to minimally preprocess raw imagery provided by imaging module 446 sufficiently to enable edge PLD 400 to generate reliable image tagging yet within a relatively limited power usage envelope (e.g., between 1/1000th and 1/10th the typical power used by controller 442 to be powered on and awake and generating similar image tagging).

In the embodiment shown in FIG. 4, electronic system 430 includes controller 432, memory 434, user interface 435, machine readable medium 43g, and user input device 437 (e.g., each similar to elements of system 130 in FIG. 1), along with imaging module 446, power supply 444, communications module 438, and edge PLD 400 (e.g., an embodiment of PLD 100 of FIG. 1). Although shown in FIG. 4 as separate from imaging module 446, in some embodiments, edge PLD 400 may be integrated with imaging module 446, so as to minimize power and/or data delivery routing between edge PLD 400 and imaging module 446, for example, and among the various elements of electronic system 430. In general, edge PLD 400 may be configured to process and tag raw imagery provided by imaging module 446 and use such tagging and/or processing to control operation of electronic system 430, for example, which may occur substantially independently of a power, wake, or sleep state of electronic system 430. In various embodiments, edge PLD 400 may be configured to use processed raw imagery to power, depower, wake, and/or sleep electronic system 430, to authenticate or deauthenticate a user access to electronic system 430, and/or otherwise control operation of electronic system 430 and/or applications executed by electronic system 430, as described herein.

Electronic system 430 may be implemented as a computing device, a laptop, a server, a smart phone, or any other personal and/or portable electronic device, for example, and may be implemented similarly with respect to system 130 of FIG. 1. In the embodiment shown in FIG. 4, controller 432 of electronic system 430 implements image processor 430 and/or operating system 442. Image processor 430 may be configured to receive raw imagery from imaging module 446 and generate human-quality imagery corresponding to the received raw imagery, where the human-quality imagery comprises one or more human-quality image characteristics and/or a human-quality processed version of the raw imagery. In general, human-quality image characteristics may correspond to relatively high quality imagery that has structural characteristics common with those of the raw imagery provided by imaging module 446, such as a resolution, a frame rate, a bit depth, a color fidelity, a dynamic range, and/or a compression state of the raw imagery, for example, and that has been processed using relatively resource intensive image processing techniques to produce imagery with human discernible objects and/or object features. Operating system 442 may be configured to apply relatively sophisticated and resource intensive (e.g., power hungry) image processing to human-quality imagery generated by image processor 440, such as full resolution, frame rate, bit depth, color fidelity, and/or other human-quality image characteristic image processing, as described herein, and to use the result of such processing to display imagery, control operation of electronic system 430, and/or control execution of various other applications executed by controller 432.

More generally, controller 432 may be implemented by any processor, CPU, GPU, and/or other logic device configured to perform the various methods described herein. In some embodiments, controller 432 may be configured to generate human-quality imagery corresponding to received raw imagery, receive one or more image tags and/or engine-quality imagery from edge PLD 400, and generate a system response based, at least in part, on the generated human-quality imagery and at least one of the one or more image tags and/or the generated engine-quality imagery provided by edge PLD 400. In some embodiments, the generating the system response may include generating tagged human-quality imagery corresponding to the received raw imagery based, at least in part, on human-quality imagery generated by controller 432 and one or more image tags provided by edge PLD 400, and displaying the tagged human-quality imagery via a display (user interface 435) of electronic system 430 and/or storing the tagged human-quality imagery according to the one or more image tags (e.g., cross referenced by the tag value) associated with the human-quality imagery. In other embodiments, the generating the system response may include generating a system alert (e.g. an audible and/or visible alert), disabling imaging module 446, disabling a display of electronic system 430, and/or depowering electronic system 430.

In related embodiments, controller 432 may be configured to receive one or more image tags and/or engine-quality imagery from edge PLD 400, and generate a system response based, at least in part, on the one or more image tags and/or the engine-quality imagery provided by edge PLD 400. In such embodiments, the system response may include generating a user input (e.g., a joystick input), generating a system alert, disabling a display, and/or depowering electronic system 430. For example, generating the user input may be performed in the context of providing user input to a game or simulated environment generated by electronic system 430, where edge PLD 400 is configured to generate image tagging comprising user face orientation tracking, for example, which may be used to adjust how the game or simulated environment is rendered to the user.

Memory 434, user interface 435, machine readable medium 436, and user input device 437 may be implemented similar to similarly named elements of system 130 of FIG. 1. Power supply 444 may be implemented as any power storage device configured to provide power to each element of system 430 and/or to provide a charge status, power draw, and/or other power characteristic of power supply 444. Imaging module 446 may be implemented as an array of detector elements, such as visible spectrum sensitive detector elements that can be arranged in a focal plane array (FPA) configured to capture and provide raw imagery of an environment about electronic system 430.

Communications module 438 may be implemented as any wired and/or wireless communications module configured to transmit and receive analog and/or digital signals between elements of system 430 and/or remote devices and/or systems. For example, communications module 438 may be configured to receive control signals and/or data and provide them to controller 432 and/or memory 434. In other embodiments, communications module 438 may be configured to receive images and/or other sensor information from imaging module 446, controller 432, and/or edge PLD 400 and relay the data within system 430 and/or to external systems. Wireless communication links may include one or more analog and/or digital radio communication links, such as WiFi and others, as described herein, and may be direct communication links, for example, or may be relayed through one or more wireless relay stations configured to receive and retransmit wireless communications. Communication links established by communications module 438 may be configured to transmit data between elements of system 430 substantially continuously throughout operation of system 430, where such data includes various types of sensor data, control parameters, and/or other data, as described herein. Other system modules 480 may include other and/or additional sensors, actuators, interfaces, communication modules/nodes, and/or user interface devices, for example. In some embodiments, other modules 480 may include other environmental sensors providing measurements and/or other sensor signals that can be displayed to a user and/or used by other devices of system 430 to provide operational control of system 430.

In various embodiments, edge PLD 400 may be implemented by elements similar to those described with respect to PLD 100 in FIG. 1, but with additional configurable and/or hard IP elements configured to facilitate image processing by edge PLD 400, as described herein. In particular, edge PLD 400 may include a PLD fabric including a plurality of configurable PLBs configured to implement an image engine preprocessor 460 of edge PLD 400 and an image engine 462 of edge PLD 400, as shown. More generally, edge PLD 400 may be implemented by any of the various elements described with respect to PLD 100 and may be configured using a design process similar to process 300 described in relation to FIG. 3 to generate and program edge PLD 400 according to a desired configuration. Specifically, edge PLD 400 may be configured to use various identified hard and/or soft IP elements identified in FIG. 4 to process raw imagery provided by imaging module 446.

Image engine preprocessor 460 may be implemented by configurable resources of edge PLD 400 and be configured to generate engine-quality imagery corresponding to received raw imagery provided by imaging module 446, as described herein. Such engine-quality imagery may be one or more of a lower resolution, a lower frame rate, a lower bit depth, a lower color fidelity, a narrower dynamic range, a relatively lossy compressed state, and/or a non-human-quality image characteristic, relative to the raw imagery and/or a human-quality processed version of the raw imagery. In various embodiments, image engine preprocessor 460 may be configured to convert a resolution, a frame rate, a bit depth, a color fidelity, a dynamic range, a compression state, and/or another image characteristic of the raw imagery to a lower resolution, a lower frame rate, a lower bit depth, a lower color fidelity, a narrower dynamic range, a relatively lossy compressed state, and/or a non-human-quality image characteristic, relative to the raw imagery and/or a human-quality processed version of the raw imagery; applying engine-quality histogram equalization to the raw imagery; applying engine-quality color correction to the raw imagery; and/or applying engine-quality exposure control to the raw imagery. A simplified, engine-quality histogram equalization may include determining three characteristic distribution values corresponding to the distribution of greyscale pixel values in an image frame (e.g., 10% min, average, 90% max, according to a Gaussian distribution), and then applying a gain function (e.g., a constant, linear, B-spline, and/or other gain function) to adjust the greyscale pixel value distribution of the image such that the three characteristic distribution values are equal to preselected target distribution values.

Image engine 462 may be implemented by configurable resources of edge PLD 400 and be configured to generate one or more image tags associated with the engine-quality imagery generated by image engine preprocessor 460. In some embodiments, image engine 462 may be implemented as a neural network, a machine learning, and/or an artificial intelligence based image processing engine, which may be trained to generate the one or more image tags by generating an engine-quality training set of training images and associated image tagging based, at least in part, on a human-quality training set of training images and associated image tagging corresponding to a desired selection of image tags, for example, and determining a set of weights for the image engine based, at least in part, on the engine-quality training set, as described herein. In various embodiments, the one or more image tags may include an object presence tag (e.g., a user presence tag), an object bounding box tag (e.g., a user face bounding box), and/or one or more object feature status tags (e.g., a particular user face tag—for authentication, a user face orientation tracking tag or tags, a user face status tag—one or both eyes open or closed, mouth open or closed, mouth smiling, face frowning, etc.)

Other PLD modules 482 may include various hard and/or soft modules and/or interlinking buses, such as a security engine, a configuration engine, a non-volatile memory (NVM), a programmable I/O, and/or other integrated circuit (IC) modules, which may all be implemented on a monolithic IC. A security engine of edge PLD 400 may be implemented as a hard IP resource configured to provide various security functions for use by edge PLD 400 and/or a configuration engine of edge PLD 400. A configuration engine of edge PLD 400 may be implemented as a hard IP resource configured to manage the configurations of and/or communications amongst the various elements of edge PLD 400. An NVM of edge PLD 400 may be implemented as a hard IP resource configured to provide securable non-volatile storage of data used to facilitate secure operation of edge PLD 400. A programmable I/O of edge PLD 400 may be implemented as at least partially configurable resources configured to provide or support a communication link between edge PLD 400 and elements of electronic system 430, for example, across a bus configured to link portions of edge PLD 400 to the programmable I/O. In some embodiments, such bus and/or programmable I/O may be integrated with edge PLD 400.

More generally, other PLD modules 482 may be implemented as a variety of any hard and/or configurable IP resources configured to facilitate operation of edge PLD 400. For example, in addition to image processing, edge PLD 400 may be configured to control various operations of electronic system 430. In some embodiments, edge PLD 400 may be configured to provide image tags and/or the engine-quality imagery to controller 432 and/or memory 434 of electronic system 430. In other embodiments, edge PLD 400 may be configured to power, wake, depower, or sleep electronic system 430 and/or authenticate or deauthenticate a user access to electronic system 430, which may be based, at least in part, on the image tags and/or the engine-quality imagery.

For example, edge PLD 400 may be configured to monitor raw imagery provided by imaging module 446 for an image tag indicating the presence of a user, for example, and power or wake electronic system 430. Upon waking electronic system 430, edge PLD 400 may be configured to monitor the raw imagery for an image tag indicating the presence of a particular user and then authenticate the particular user to electronic system 430 (e.g., trigger OS 442 to log the user in). Edge PLD 400 may be configured to monitor the raw imagery for lack of a presence of a user or a particular user and deauthenticate (e.g., log off) the user or control electronic system 430 to sleep or depower. In alternative embodiments, edge PLD 400 may be configured to monitor a charge state of power supply 444 of electronic system 430 and control a frame rate of imaging module 446 based, at least in part, on the monitored charge state of power supply 444 (e.g., reduce the frame rate to save power when the charge state is below a preselected low power threshold value).

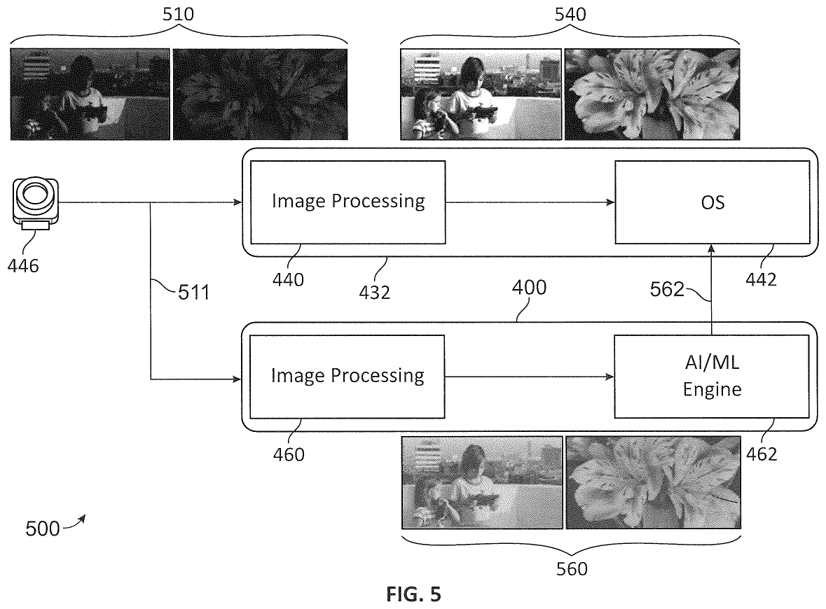

FIG. 5 illustrates a data flow diagram 500 of electronic system 430 including edge PLD 400 in accordance with an embodiment of the disclosure. In FIG. 5, data flow diagram 500 shows raw imagery 510 provided by imaging module 446 being delivered to controller 432 and/or edge PLD 400 via raw image pathway 511. In some embodiments, controller 432 and much of the rest of electronic system 430 may be in a sleep state or depowered, for example, except for imaging module 446 and edge PLD 400. In such embodiments, edge PLD 400 may be configured to receive raw imagery provided by imaging module 446, generate engine-quality imagery 560 (e.g., via image engine preprocessor 460), and generate one or more image tags associated with the generated engine-quality imagery 560 (e.g., via image engine 462) for delivery to controller 432 via edge PLD link 562. In various embodiments, raw image pathway 511 and/or edge PLD link 562 may be coupled between edge PLD 400 and controller 432 and/or various other elements of electronic system 430.

In other embodiments, controller 432 and/or system 430 may be powered and/or awake (e.g., providing dual image processing paths, as shown), and edge PLD 400 and controller 432 may be configured to process raw imagery provided by imaging module 446 substantially simultaneously, for example, such that the one or more tags and/or associated engine-quality imagery 560 provided to OS 442 of controller 432 may be linked with human-quality processed versions of the same raw image frames (e.g., human-quality imagery 540) sourced from imaging module 446. In further embodiments, the one or more tags and/or associated engine-quality imagery provided to OS 442 of controller 432 may be used to control operation of electronic system 430 without explicitly being linked to human-quality processed versions of the raw imagery provided by imaging module 446, as described herein.

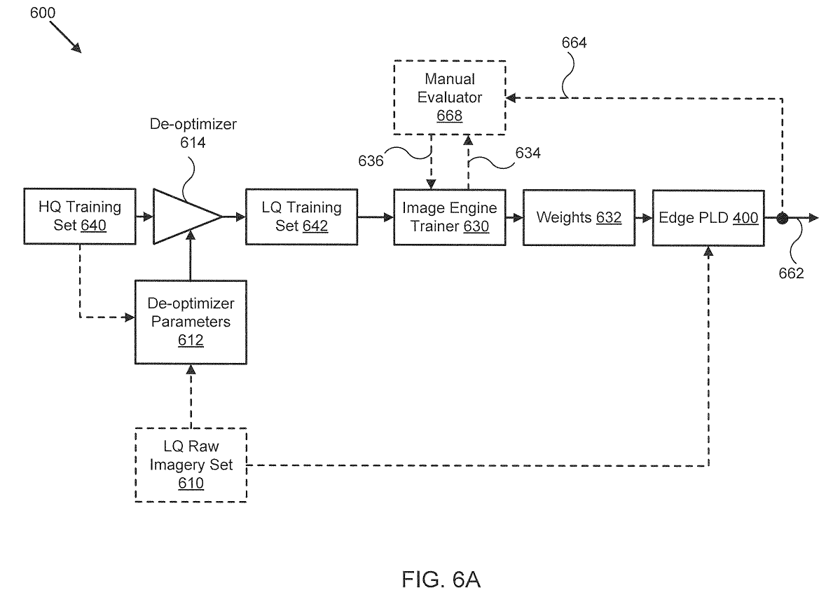

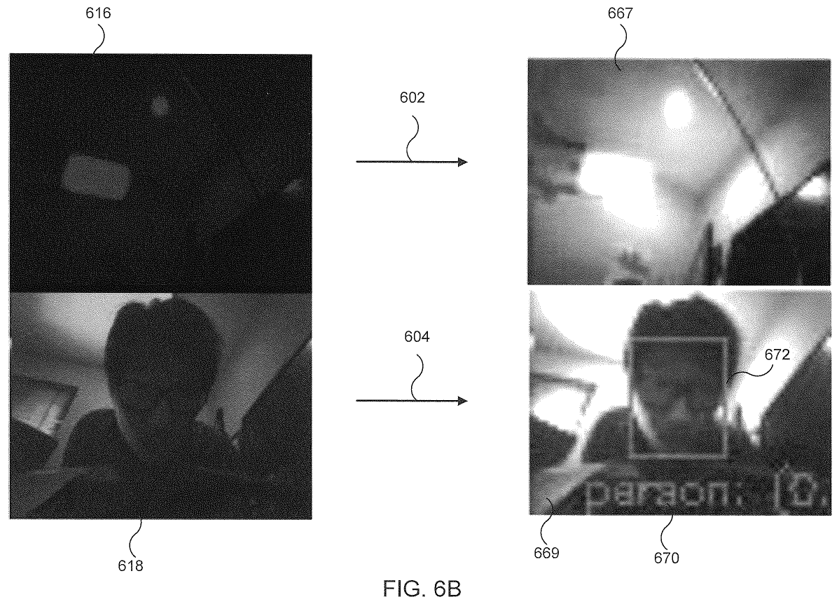

FIG. 6A illustrates a block diagram of a training system 600 for edge PLD 400 in accordance with an embodiment of the disclosure. In the embodiment shown in FIG. 6A, training system 600 includes de-optimizer 614 configured to generate relatively low engine-quality training set 642 based, at least in part, on relatively high human-quality training set 640, which is then provided to image engine trainer 630 to determine weights 632 for edge PLD 400. In various embodiments, de-optimizer 614 and/or image engine trainer 630 may be implemented by a computing system similar to system 130 of FIG. 1. Human-quality training set 640 may include a plurality of human-quality training images and associated image tags, which may be generated by a separate human-quality image engine, for example, or may be annotated/tagged manually. Engine-quality training set 642 may include a plurality of engine-quality training images and associated image tags (e.g., based on and/or equal to the image tags of human-quality training set 640), generated by de-optimizer 614. Such engine-quality training images may be generated to mimic common unfavorable image capture circumstances and/or characteristics, as opposed to engine-quality imagery 560 generated by image engine preprocessor 460 with reduced quality relative to raw imagery 510 provided by imaging module 446. In some embodiments, de-optimizer 614 may be configured according to de-optimizer parameters 612 based on human input selecting for common unfavorable image capture circumstances and/or characteristics, for example, and configured to convert human-quality training set 640 into engine-quality training set 642. In optional embodiments, de-optimizer parameters 612 may be determined based on example low quality raw imagery set 610 provided by imaging module 446 and/or a comparison of low quality raw imagery set 610 to imagery within human-quality training set 640.

Image engine trainer 630 may be configured to determine weights 632 for image engine 462 of edge PLD 400 based, at least in part, on engine-quality training set 642. In optional embodiments, image engine trainer 630 may be configured to provide tagged imagery and/or other imaging tagging results 634 to manual evaluator 668, which may be used to manually adjust such image tagging and provide manual feedback 636 to image engine trainer 630, such that updated weights 632 are generated based, at least in part, on engine-quality training set 642 and manual feedback 636. In further optional embodiments, manual evaluator 668 may generate manual feedback 636 based, at least in part, on imaging tagging results 634 and image tags and/or engine-quality imagery (feedback 664 of output 662) generated by edge PLD 400, as shown. In all related embodiments, weights 662 may be integrated with a configuration for edge PLD 400 and used to configure image engine 462 of edge PLD 400.

FIG. 6B illustrates imagery processed by edge PLD 400 in accordance with an embodiment of the disclosure. For example, raw image frame 616 provided by imaging module 446 exhibits low light and lack of detail and/or other unfavorable image capture characteristics, and after processing steps 602 performed by edge PLD 400, the resulting tagged engine-quality image frame 667 shows a reduction in resolution, bit depth, and/or color fidelity, and is appropriately tagged as no-user-present. Raw image frame 618 provided by imaging module 446 also exhibits low light and lack of detail and/or other unfavorable image capture characteristics, and after processing steps 604 performed by edge PLD 400, the resulting tagged engine-quality image frame 669 shows a reduction in resolution, bit depth, and/or color fidelity, and is appropriately tagged as user-present (object presence tag 670), with a user face bounding box (e.g., object bounding box tag 672), but without a particular user tag or face tracking or status tag (e.g., object feature status tags).

FIG. 7 illustrates a process for operating an electronic system including an edge PLD in accordance with an embodiment of the disclosure. In some embodiments, the operations of FIG. 7 may be implemented as software instructions executed by one or more logic devices associated with corresponding electronic devices, modules, systems, and/or structures depicted in FIGS. 1-6B. More generally, the operations of FIG. 7 may be implemented with any combination of software instructions and/or electronic hardware (e.g., inductors, capacitors, amplifiers, actuators, or other analog and/or digital components). It should be appreciated that any step, sub-step, sub-process, or block of process 700 may be performed in an order or arrangement different from the embodiments illustrated by FIG. 7. For example, in other embodiments, one or more blocks may be omitted from process 700, and other blocks may be included. Furthermore, block inputs, block outputs, various sensor signals, sensor information, calibration parameters, and/or other operational parameters may be stored to one or more memories prior to moving to a following portion of process 700. Although process 700 is described with reference to systems, devices, and elements of FIGS. 1-6B, process 700 may be performed by other systems, devices, and elements, and including a different selection of electronic systems, devices, elements, assemblies, and/or arrangements. At the initiation of process 700, various system parameters may be populated by prior execution of a process similar to process 700, for example, or may be initialized to zero and/or one or more values corresponding to typical, stored, and/or learned values derived from past operation of process 700, as described herein.

In block 710, a logic device receives raw imagery. For example, edge PLD 400 (e.g., image engine 462 of edge PLD 400) may be configured to receive raw imagery provided by imaging module 446 of electronic system 430. In some embodiments, both edge PLD 400 and controller 432 of electronic system 430 may be configured to receive raw imagery provided by imaging module 446, for example, and be configured to uniquely identify image frames within the imagery so as to be able to link image tagging provided by edge PLD 400 with imagery passed directly into and/or through controller 432, as described herein.

In block 720, a logic device generates engine-quality imagery. For example, image engine preprocessor 460 of edge PLD 400 may be configured to generate engine-quality imagery corresponding to the raw imagery received in block 710. In some embodiments, the engine-quality imagery may be characterized according to one or more of a lower resolution, a lower frame rate, a lower bit depth, a lower color fidelity, a narrower dynamic range, a relatively lossy compressed state, and/or a non-human-quality image characteristic, relative to the raw imagery and/or a human-quality processed version of the raw imagery. More generally, image engine preprocessor 460 may be configured to generate engine-quality imagery by converting a frame rate, a bit depth, a color fidelity, a dynamic range, a compression state, and/or another image characteristic of the raw imagery to a lower resolution, a lower frame rate, a lower bit depth, a lower color fidelity, a narrower dynamic range, a relatively lossy compressed state, and/or a non-human-quality image characteristic, relative to the raw imagery and/or a human-quality processed version of the raw imagery. Image engine preprocessor 460 may also be configured to generate engine-quality imagery by applying engine-quality histogram equalization to the raw imagery, applying engine-quality color correction to the raw imagery, and/or applying engine-quality exposure control to the raw imagery, as described herein.

In block 730, a logic device generates image tags associated with engine-quality imagery. For example, image engine 462 of edge PLD 400 may be configured to generate one or more image tags associated with the engine-quality imagery generated in block 720 and/or corresponding to the raw imagery received in block 710. In some embodiments, the one or more image tags may include an object presence tag, an object bounding box tag, and/or one or more object feature status tags, as described herein. In some embodiments, edge PLD 400 may be configured to provide the one or more image tags and/or the generated engine-quality imagery to controller 432 and/or memory 434 of electronic system 430. In other embodiments, edge PLD 400 may be configured to power, wake, depower, or sleep electronic system 430 and/or authenticate or deauthenticate a user access to electronic system 430 based, at least in part, on the one or more image tags and/or the generated engine-quality imagery. In further embodiments, edge PLD 400 may be configured to monitor a charge state of power supply 444 of electronic system 430 and control a frame rate of imaging module 446 based, at least in part, on the monitored charge state of power supply 444.

In various embodiments, image engine 462 may be trained to generate the one or more image tags by generating engine-quality training set 642 of training images and associated image tagging based, at least in part, on human-quality training set 640 of training images and associated image tagging corresponding to a desired selection of image tags, for example, and determining a set of weights 632 for image engine 462 of edge PLD 400 based, at least in part, on engine-quality training set 642.

In block 740, a logic device generates human-quality imagery. For example, controller 432 of electronic system 430 may be configured to generate human-quality imagery corresponding to the raw imagery received in block 710, where the human-quality imagery includes one or more human-quality image characteristics and/or a human-quality processed version of the raw imagery, as described herein.

In block 750, a logic device generates a system response. For example, controller 432 of electronic system 430 may be configured to receive the one or more image tags and/or the engine-quality imagery generated in blocks 720 and 730 from edge PLD 400 and to generate a system response based, at least in part, on at least one of the one or more image tags, the engine-quality imagery, and/or the human-quality imagery generated in block 740, as described herein. In some embodiments, controller 432 may be configured to generate the system response based, at least in part, on at least one of the one or more image tags and the engine-quality imagery provided by edge PLD 400.

In some embodiments, the generating the system response may include generating tagged human-quality imagery corresponding to the received raw imagery based, at least in part, on the generated human-quality imagery and the one or more image tags provided by the edge PLD, and displaying the tagged human-quality imagery via a display of the electronic system and/or storing the tagged human-quality imagery according to the one or more image tags associated with the human-quality imagery, such as part of a video conferencing application executed by electronic system 430. In other embodiments, the generating the system response may include generating a system alert, disabling the imaging module of electronic system 430, disabling the display of electronic system 430, and/or depowering electronic system 430. In further embodiments, the generating the system response may include generating a user input based, at least in part, on the one or more image tags and/or the generated engine-quality imagery, such as a joystick or other user input (e.g., a user face orientation) for a game or a simulated environment.

Thus, by employing the systems and methods described herein, embodiments of the present disclosure are able to provide relatively low power, flexible, and feature rich image processing for use by relatively sophisticated imagery-based features and applications, including providing always-on operational control for a variety of different electronic systems under non-optimal environmental imaging conditions.

Where applicable, various embodiments provided by the present disclosure can be implemented using hardware, software, or combinations of hardware and software. Also, where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as non-transitory instructions, program code, and/or data, can be stored on one or more non-transitory machine-readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the present invention. Accordingly, the scope of the invention is defined only by the following claims.

What is claimed is:

1. An electronic system comprising:
an edge programmable logic device (PLD), wherein the edge PLD comprises a plurality of programmable logic blocks (PLBs) configured to implement an image engine preprocessor of the edge PLD and an image engine of the edge PLD, wherein the edge PLD is configured to perform a computer-implemented method comprising:
receiving raw imagery provided by an imaging module of the electronic system via a raw image pathway of the electronic system;
generating, via the image engine preprocessor of the edge PLD, engine-quality imagery corresponding to the received raw imagery; and
generating, via the image engine of the edge PLD, one or more image tags associated with the generated engine-quality imagery.

2. The electronic system of claim 1, wherein:
the engine-quality imagery comprises one or more of a lower resolution, a lower frame rate, a lower bit depth, a lower color fidelity, a narrower dynamic range, a relatively lossy compressed state, and/or a non-human-quality image characteristic, relative to the raw imagery and/or a human-quality processed version of the raw imagery.

3. The electronic system of claim 1, wherein the generating the engine-quality imagery comprises:
converting a resolution, a frame rate, a bit depth, a color fidelity, a dynamic range, a compression state, and/or another image characteristic of the raw imagery to a lower resolution, a lower frame rate, a lower bit depth, a lower color fidelity, a narrower dynamic range, a relatively lossy compressed state, and/or a non-human-quality image characteristic, relative to the raw imagery and/or a human-quality processed version of the raw imagery;
applying engine-quality histogram equalization to the raw imagery;
applying engine-quality color correction to the raw imagery; and/or
applying engine-quality exposure control to the raw imagery.

4. The electronic system of claim 1, wherein:
the one or more image tags comprises an object presence tag, an object bounding box tag, and/or one or more object feature status tags.

5. The electronic system of claim 1, wherein the computer-implemented method further comprises:
providing the one or more image tags and/or the generated engine-quality imagery to a controller and/or a memory of the electronic system.

6. The electronic system of claim 1, wherein the computer-implemented method further comprises:
powering, waking, depowering, or sleeping the electronic system and/or authenticating or deauthenticating a user access to the electronic system based, at least in part, on the one or more image tags and/or the generated engine-quality imagery.

7. The electronic system of claim 1, wherein the computer-implemented method further comprises:
monitoring a charge state of a power supply of the electronic system; and
controlling a frame rate of the imaging module based, at least in part, on the monitored charge state of the power supply.

8. The electronic system of claim 1, further comprising:
a controller and a memory coupled to the edge PLD and configured to receive the raw imagery provided by the imaging module via the raw image pathway, wherein the memory comprises machine-readable instructions which when executed by a processor of an external system are adapted to cause the external system to:
generate human-quality imagery corresponding to the received raw imagery, wherein the human-quality imagery comprises one or more human-quality image characteristics and/or a human-quality processed version of the raw imagery;
receive the one or more image tags and/or the generated engine-quality imagery from the edge PLD; and
generate a system response based, at least in part, on the generated human-quality imagery and at least one of the one or more image tags and/or the generated engine-quality imagery provided by the edge PLD.

9. The electronic system of claim 8, wherein the generating the system response comprises:
generating tagged human-quality imagery corresponding to the received raw imagery based, at least in part, on the generated human-quality imagery and the one or more image tags provided by the edge PLD, and displaying the tagged human-quality imagery via a display of the electronic system and/or storing the tagged human-quality imagery according to the one or more image tags associated with the human-quality imagery; and/or
generating a system alert, disabling the imaging module of the electronic system, disabling the display of the electronic system, and/or depowering the electronic system.

10. The electronic system of claim 1, further comprising:
a controller and a memory coupled to the edge PLD and configured to receive the raw imagery provided by the imaging module via the raw image pathway, wherein the memory comprises machine-readable instructions which when executed by a processor of an external system are adapted to cause the external system to:
receive the one or more image tags and/or the generated engine-quality imagery from the edge PLD; and
generate a system response based, at least in part, on the one or more image tags and/or the generated engine-quality imagery, wherein the generating the system response comprises generating a user input, generating a system alert, disabling a display of the electronic system, and/or depowering the electronic system.

11. The electronic system of claim 1, wherein:
the image engine of the edge PLD is implemented as a neural network, a machine learning, and/or an artificial intelligence-based image processing engine; and
the image engine of the edge PLD is trained to generate the one or more image tags by:
generating an engine-quality training set of training images and associated image tagging based, at least in part, on a human-quality training set of training images and associated image tagging corresponding to a desired selection of image tags; and
determining a set of weights for the image engine based, at least in part, on the engine-quality training set.

12. A method for operating an electronic system including an edge programmable logic device (PLD) implementing an image engine preprocessor and an image engine, the method comprising:
receiving raw imagery provided by an imaging module of the electronic system via a raw image pathway of the electronic system;
generating, via the image engine preprocessor of the edge PLD, engine-quality imagery corresponding to the received raw imagery; and
generating, via the image engine of the edge PLD, one or more image tags associated with the generated engine-quality imagery.

13. The method of claim 12, wherein:
the engine-quality imagery comprises one or more of a lower resolution, a lower frame rate, a lower bit depth, a lower color fidelity, a narrower dynamic range, a relatively lossy compressed state, and/or a non-human-quality image characteristic, relative to the raw imagery and/or a human-quality processed version of the raw imagery.

14. The method of claim 12, wherein the generating the engine-quality imagery comprises:
converting a resolution, a frame rate, a bit depth, a color fidelity, a dynamic range, a compression state, and/or another image characteristic of the raw imagery to a lower resolution, a lower frame rate, a lower bit depth, a lower color fidelity, a narrower dynamic range, a relatively lossy compressed state, and/or a non-human-quality image characteristic, relative to the raw imagery and/or a human-quality processed version of the raw imagery;
applying engine-quality histogram equalization to the raw imagery;
applying engine-quality color correction to the raw imagery; and/or
applying engine-quality exposure control to the raw imagery.

15. The method of claim 12, wherein:
the one or more image tags comprises an object presence tag, an object bounding box tag, and/or one or more object feature status tags.

16. The method of claim 12, further comprising:
providing the one or more image tags and/or the generated engine-quality imagery to a controller and/or a memory of the electronic system.

17. The method of claim 12, further comprising:
powering, waking, depowering, or sleeping the electronic system and/or authenticating or deauthenticating a user access to the electronic system based, at least in part, on the one or more image tags and/or the generated engine-quality imagery.

18. The method of claim 12, further comprising:
monitoring a charge state of a power supply of the electronic system; and
controlling a frame rate of the imaging module based, at least in part, on the monitored charge state of the power supply.

19. The method of claim 12, further comprising:
generating human-quality imagery corresponding to the received raw imagery, wherein the human-quality imagery comprises one or more human-quality image characteristics and/or a human-quality processed version of the raw imagery;
receiving the one or more image tags and/or the generated engine-quality imagery from the edge PLD; and
generating a system response based, at least in part, on the generated human-quality imagery and at least one of the one or more image tags and/or the generated engine-quality imagery provided by the edge PLD.

20. The method of claim 19, wherein the generating the system response comprises:
generating tagged human-quality imagery corresponding to the received raw imagery based, at least in part, on the generated human-quality imagery and the one or more image tags provided by the edge PLD, and displaying the tagged human-quality imagery via a display of the electronic system and/or storing the tagged human-quality imagery according to the one or more image tags associated with the human-quality imagery; and/or
generating a system alert, disabling the imaging module of the electronic system, disabling the display of the electronic system, and/or depowering the electronic system.

21. The method of claim 12, further comprising:
receiving the one or more image tags and/or the generated engine-quality imagery from the edge PLD; and
generating a system response based, at least in part, on the one or more image tags and/or the generated engine-quality imagery, wherein the generating the system response comprises generating a user input, generating a system alert, disabling a display of the electronic system, and/or depowering the electronic system.

22. The method of claim 12, wherein:
the image engine of the edge PLD is implemented as a neural network, a machine learning, and/or an artificial intelligence-based image processing engine; and
the image engine of the edge PLD is trained to generate the one or more image tags by:
generating an engine-quality training set of training images and associated image tagging based, at least in part, on a human-quality training set of training images and associated image tagging corresponding to a desired selection of image tags; and
determining a set of weights for the image engine based, at least in part, on the engine-quality training set.
